(19) United States
(12) Patent Application Publication
(10) Pub. No.: US 2004/0225547 A1
(43) Pub. Date: Nov. 11, 2004

(54) Method of controlling a computer that manages user's schedule

(75) Inventor: Masaki Yamashima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/786,057

(22) Filed: Feb. 26, 2004

(30) Foreign Application Priority Data
May 8, 2003 (JP) 2003-130561

(51) Int. Cl. G06F 17/60

(52) U.S. Cl. 705/8

(57) ABSTRACT

A method of controlling a computer managing user's schedule is disclosed. The method includes the steps of: setting a first time; determining whether present time is within the first time before a going-out time at which the user is to go out; and setting the computer at a going-out mode in response to the determination. The method may further include the steps of: setting a second time; determining whether the present time is within the second time before the going-out time; controlling a power supply of the computer; wherein after the computer is set in the going-out mode, the power supply is turned off in response to the determination. The method enables the computer to control the power supply based on the state of the user and the user's schedule managed thereby.

### BACKGROUND OF THE INVENTION

1. Field of the Invention

The present invention generally relates to a method of controlling a computer, and more particularly, to a method of controlling a computer that manages user's schedule, the computer having a user detection unit for detecting the user.

2. Description of the Related Art

Computers are often used for managing personal schedules of users. The user's schedule is input into the computer and is stored therein. The computer may display a message or sound alarm at a certain time prior to an appointment, for example, for letting the user know that it is time to prepare for the appointment.

As described above, the computer can perform a predetermined operation (displaying a message or sounding an alarm) in accordance with the input schedule. The computer can even turn itself on and off at a predetermined time designated by the user. The computer follows the schedule designated by the user in this case.

The following documents disclose related art: Japanese Laid-Open Patent Applications No. 11-272920 and No. 57-36326.

The computer according to the related art, however, merely follows the schedule designated by the user. Even if the user's actual schedule has been changed, the- computer follows the designated schedule until the user changes it.

### SUMMARY OF THE INVENTION

Accordingly, it is a general object of the present invention to provide a novel and useful method of controlling a computer in which one or more of the problems described above are eliminated.

Another and more specific object of the present invention is to provide a method of controlling the power supply of a computer that manages user's schedule, the computer provided with a user detection device, to provide a computer that performs the method, and to provide a computer program that causes the computer to perform the method.

To achieve one or more of the above objects, a method of controlling a computer that manages user's schedule, according to the present invention, includes the steps of:

setting a first time;

determining whether a present time is within the first time before a going-out time at which the user is to go out; and

setting the computer in an going-out mode in response to a determination that the present time is within the first time before the going-out time.

According to the present invention, the method as described above further includes the steps of:

setting a second time;

determining whether the present time is within the second time before the going-out time;

controlling a power supply of the computer;

after the computer is set at the going-out mode, turning the power supply off in response to the determination that the present time is within the second time before the going-out time.

The method according to the present invention enables the computer to control the power supply thereof based on the state of the user and the user's schedule managed thereby. According to these arrangements, the computer becomes more useful.

Other objects, features, and advantages of the present invention will be more apparent from the following detailed description when read in conjunction with the accompanying drawings.

### BRIEF DESCRIPTION OF THE DRAWINGS

FIG. 1 is a block diagram showing a computer to which a method according to a first embodiment of the present invention is applied;

FIG. 2 is a chart showing the state transition of the method according to the first embodiment;

FIG. 3 is a flowchart showing the operation of the method according to the first embodiment;

FIG. 4 is a chart showing the state transition of a method according to a second embodiment;

FIG. 5 is a flowchart showing the operation of the method according to the second embodiment;

FIG. 6 is a schematic diagram showing a computer according to the second embodiment;

FIG. 7 is an exemplary screen showing a schedule displayed by a schedule manager according to an embodiment;

FIG. 8 is a flowchart showing the operation of the computer according to the second embodiment;

FIG. 9 is a schematic diagram showing a computer according to a third embodiment;

FIG. 10 is a flowchart showing the operation of the computer according to the third embodiment;

FIG. 11 is a schematic diagram showing a computer according to a fourth embodiment; and

FIG. 12 is a flowchart showing the operation of the computer according to the fourth embodiment.

### DETAILED DESCRIPTION OF THE PREFERRED EMBODIMENTS

A detailed description of the preferred embodiments according to the present invention is given below with reference to the drawings.

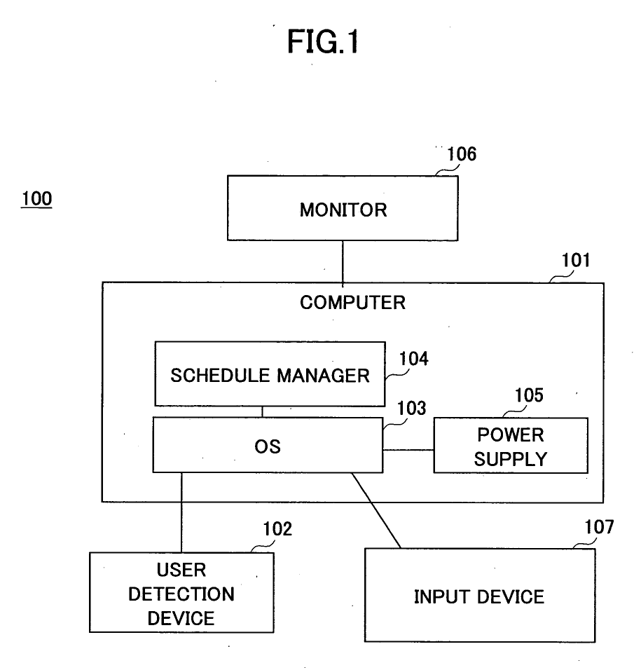

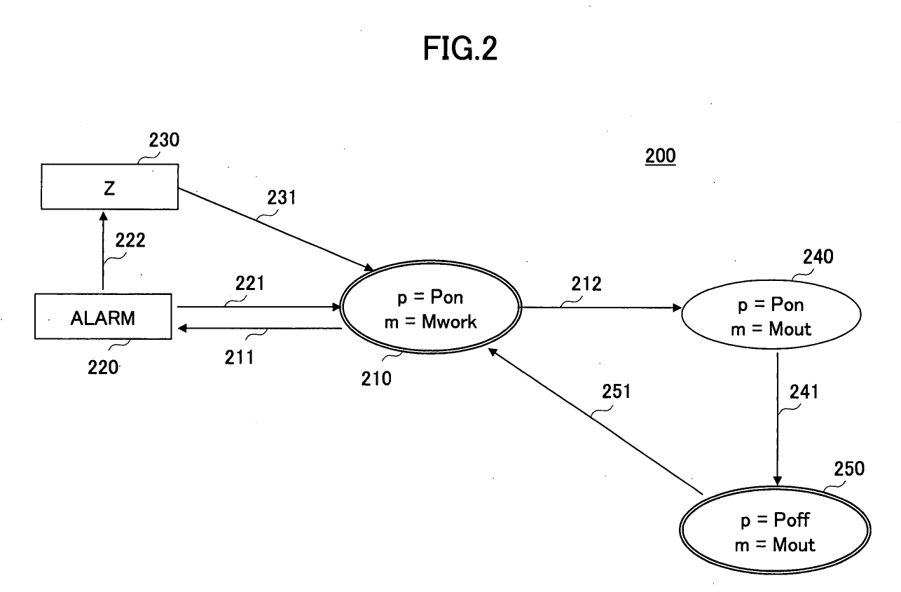

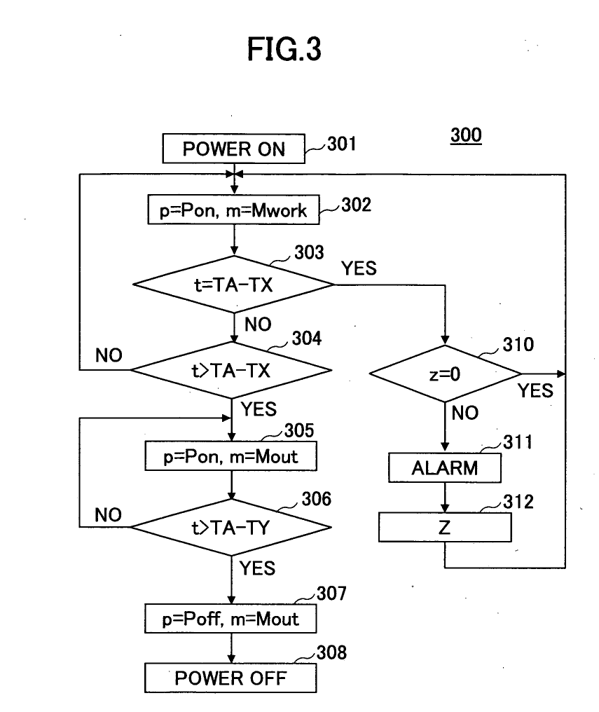

FIGS. 1 through 3 show a first embodiment of the present invention. FIG. 1 is a block diagram showing a computer according to the first embodiment. FIG. 2 is a chart showing the state transition of the computer according to the first embodiment. FIG. 3 is a flowchart showing the operation of the computer according to the first embodiment.

The computer (system) 100 shown in FIG. 1 includes a computer (processing unit) 101, a user detection device 102, a monitor 106, and an input device 107 such as a keyboard. An operating system (OS) 103 is executed on the computer 101, and a schedule manager (software) 104 is executed under the control of the operating system 103. The computer 101 includes a power supply 105. The operating system 103 can control the power supply 105.

The user detection device 102 determines whether the user is around the computer 101. When the user leaves from the computer 101 (distant from the computer 101 by more than a predetermined distance), the user detection device 102 informs the computer 101 that the user is not around the computer 101. When the user approaches the computer 101 (distant from the computer 101 by less than the predetermined distance), the user detection device 102 informs the computer 101 that the user is around the computer 101.

The schedule manager (software) 104 stores and manages the user's personal schedule. If the user needs to go out for an appointment, for example, the item of the schedule (the appointment) is identified by a flag.

The following symbols are referred to in the description given below.

“TA” denotes the time at which an appointment begins. “TX” denotes the time period after a message or an alarm is given and before the appointment begins. The message or alarm is given at time “TA-TX”. “TY” denotes the time period after the power supply of the computer is turned off and before an appointment begins. “TX” is longer than “TY” (TX>TY). “t” denotes the present time.

“Mwork” denotes a state in which the computer 101 operates normally. “Mout” denotes a state in which the computer 101 knows that the user has gone out, for example. “m” denotes the present state of the computer 101. “Pon” denotes a state in which the power supply 105 is turned on. “Poff” denotes a state in which the power supply 105 is turned off. “p” denotes the present state of the power supply 105. “Z” denotes an operation related to the time “t=TA-TX”. And, “z” is set to 0 if no operation is related by the user, and is set to Z if the operation “Z” is related by the user, for example.

A state (m=Mout) in which the computer 101 knows (is informed) that the user has gone out is referred to as an going-out mode. The computer 101 performs predetermined operations described below.

Referring to FIGS. 2 and 3, a first embodiment is described. FIGS. 2 and 3 show the operation in which the power supply 105 is controlled without the user detection device 102 being used.

FIG. 2 shows a state transition chart of both the power supply 105 and the schedule manager 104. The state transition chart includes five states 210, 220, 230, 240, and 250.

In the state 210, the power supply 105 is on, and the computer 101 operates normally.

In the state 220, the message is sent or the alarm is sounded prior to an item of schedule.

In the state 230, the operation “Z” related by the user is performed.

In the state 240, the power supply 105 is on, and the computer 101 knows that the user has gone out.

In the state 250, the power supply 105 is off, and the computer 101 knows that the user has gone out.

Each transition from one state to another is indicated by an arrow 211, 212, 221, 222, 231, 241, and 251.

FIG. 3 is a flowchart showing the operation of the computer 101, the states of which transit as shown in FIG. 2. The operation according to the present embodiment is described below with reference to FIGS. 2 and 3.

In step 301, the power supply 105 is turned on. The process proceeds to step 302. The flow from step 301 to step 302 shown in FIG. 3 corresponds to the transition 251 from the state 250 to the state 210 shown in FIG. 2.

In step 302, the power supply 105 is on, and the computer 101 operates normally. Step 302 shown in FIG. 3 corresponds to the state 210 shown in FIG. 2.

In step 303, a determination is made of whether “t” is equal to “TA-TX.” If the determination is made that “t” is equal to “TA-TX”, the process proceeds to step 310. The flow from step 303 to step 310 shown in FIG. 3 corresponds to the transition 211 from the state 210 to the state 220 shown in FIG. 2.

In step 310, a determination of whether z=0 is made. If z=0, the process proceeds to step 302. The flow from step 310 to step 302 shown in FIG. 3 corresponds to the transition 221 from the state 220 to the state 210 shown in FIG. 2. If z is not equal to 0, the process proceeds to step 311.

In step 311, an alarm is sounded or a message is sent. Step 311 corresponds to the state 220 shown in FIG. 2. The process proceeds to step 312. The flow from step 311 to step 312 corresponds to the transition 222 from the state 220 to the state 230 shown in FIG. 2. As described above, when the present time “t” becomes equal to “TA-TX”, and if z=0, the schedule manager (software) 104 displays a message or sounds an alarm to inform the user that the time (of the item of schedule) is coming.

In step 312, the operation Z related by the user is performed. That is, when the present time “t” is equal to “TA-TX”, if “z” is set at “z=Z”, the operation “Z” is performed. The process then proceeds to step 302. The flow from step 312 to step 302 corresponds to the transition 231 from the state 230 to the state 210 shown in FIG. 2.

If a determination is made that “t” is not equal to “TA-TX” in step 303, the process proceeds to step 304. In step 304, a determination is made as to whether the present time “t” is greater (later) than “TA-TX”. If “t” is not greater than “TA-TX”, the process returns to step 302, and the steps described above are repeated. If a determination is made that “t” is greater than “TA-TX”, the process proceeds to step 305. The flow from step 304 to step 305 corresponds to the transition 212 from the state 210 to the state 240 shown in FIG. 2.

In step 305, the power supply 105 remains on, and the computer 101 learns (determines) that the user has gone out. As described above, if the computer determines that the present time “t” is greater than “TA-TX”, the state of the computer 101 transits from “m=Mwork” to “m=Mout” (corresponding to the state 240 shown in FIG. 2). The process proceeds to step 306.

In step 306, a determination is made of whether “t” is greater (later) than “TA-TY”. If the determination is made that “t” is not greater than “TA-TY”, the process proceeds to step 305, and repeats step 305 until the determination is made that “t” is greater than “TA-TY”. If the determination is made that “t” is greater than “TA-TY”, the process returns to step 307. The flow from step 306 to step 307 corresponds to the transition 241 from the state 240 to the state 250 shown in FIG. 2.

In step 307, the power supply 105 is turned off, and the computer 101 knows that the user has gone out. Step 307 corresponds to the state 250 shown in FIG. 2. As described above, when the present time “t” becomes greater than “TA-TY”, the state of the power supply 105 of the computer 101 transits from a state of P=Pon to that of P=Poff.

Finally, the process proceeds to step 308. The power supply 105 of the computer 101 remains turned off.

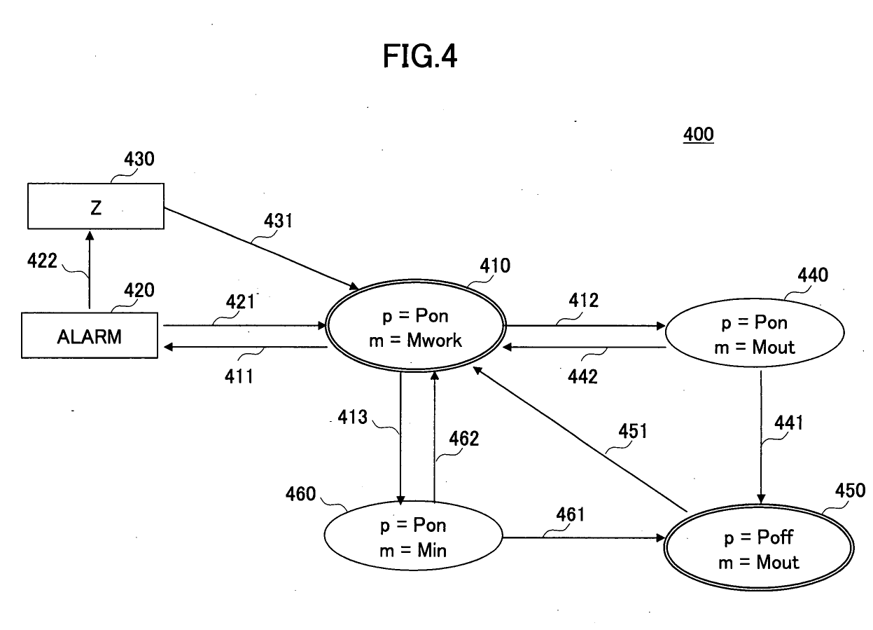

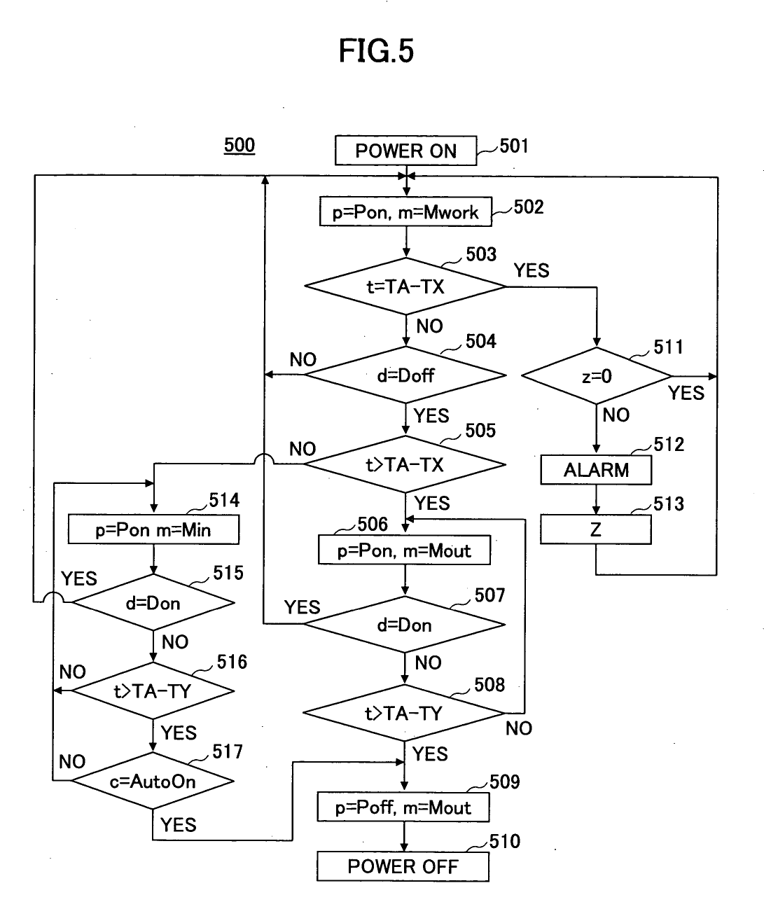

A second embodiment of the present invention is described with reference to FIGS. 1, 4, and 5. As described above, FIG. 1 is the block diagram showing the computer (system) 100 according to the first embodiment. The structure of the computer system according to the second embodiment is basically the same as that of the first embodiment, and accordingly FIG. 1 is referred to. FIG. 4 is a chart showing the state transition of the computer 101 according to the second embodiment. FIG. 5 is a flowchart showing the operation of the computer 101 according to the second embodiment.

The symbols used in FIGS. 4 and 5 are the same as those used in FIGS. 2 and 3.

In addition to the above, the following symbols may be used in FIGS. 4 and 5. “Don” and “Doff” denote a state in which the user detection device 102 detects that there is a user and a state in which the user detection device 102 detects that there is not a user, respectively. “d” denotes information that the user detection device 102 provides to the computer 101. “Min” denotes a state in which the schedule manager 104 understands that the user has stepped out but has not gone out. The state in which the schedule manager 104 understands that the user has stepped out (m=Min) is referred to as a stepping-out mode. The computer 101 performs a predetermined operation as described above in the stepping-out mode. “c=AutoOn” denotes a setting designated by the user in which the computer 101 is automatically turned off while the user has gone out. “c=AutoOff” denotes a setting designated by the user in which the computer 101 does not automatically turn off (that is, the computer does nothing) while the user has gone out.

The operation of the computer 101 according to the second embodiment is described with reference to FIGS. 4 and 5. The computer 101 controls the power supply provided therein depending on the determination, using the user detection device 102, of whether the user is around.

FIG. 4 shows a state transition chart of both the power supply 105 and the schedule manager 104. The state transition chart includes six states 410, 420, 430, 440, 450, and 460.

In the state 410, the power supply 105 is on, and the computer 101 operates normally.

In the state 420, the message is sent or the alarm is sounded prior to an item of schedule.

In the state 430, the operation “Z” related by the user is performed.

In the state 440, the power supply 105 is on, and the computer 101 knows that the user has gone out.

In the state 450, the power supply 105 is off, and the computer 101 knows that the user has gone out.

In the state 460, the power supply 105 is on, and the schedule manager 104 knows that the user has stepped out.

Each transition from one state to another is indicated by an arrow 411, 412, 421, 422, 431, 441, 451, 461, and 462.

FIG. 5 is a flowchart showing the operation of the computer 101, the states of which transit as shown in FIG. 4. The operation according to the present embodiment is described below with reference to FIGS. 4 and 5.

In step 501, the power supply 105 is turned on. The process proceeds to step 502. The flow from step 501 to step 502 shown in FIG. 5 corresponds to the transition 451 from the state 450 to the state 410 shown in FIG. 4.

In step 502, the power supply 105 is on, and the computer 101 operates normally. Step 502 shown in FIG. 5 corresponds to the state 410 shown in FIG. 4.

In step 503, a determination is made as to whether “t” is equal to “TA-TX.” If the determination is made that “t” is equal to “TA-TX”, the process proceeds to step 511. The flow from step 503 to step 511 shown in FIG. 5 corresponds to the transition 411 from the state 410 to the state 420 shown in FIG. 4.

In step 511, a determination of whether z=0 is made. If z=0, the process proceeds to step 502. The flow from step 511 to step 502 shown in FIG. 5 corresponds to the transition 421 from the state 420 to the state 410 shown in FIG. 4. If z is not equal to 0, the process proceeds to step 512.

In step 512, the message is sent or the alarm is sounded. Step 512 corresponds to the state 420 shown in FIG. 4. The process proceeds to step 513. The flow from step 512 to step 513 corresponds to the transition 422 from the state 420 to the state 430 shown in FIG. 4. In the case in which d=Don (a state in which the user detection device 102 detects the user), when the present time “t” becomes equal to “TA-TX”, and if z=0, the schedule manager (software) 104 displays a message or sounds the alarm to inform the user that the time (of the item of schedule) is coming.

In step 513, the operation Z related by the user is performed. That is, when the present time “t” is equal to “TA-TX”, if “z” is set at “z=Z”, the operation “Z” is performed. The process then proceeds to step 502. The flow from step 513 to step 502 corresponds to the transition 431 from the state 430 to the state 410 shown in FIG. 4.

If a determination is made that “t” is not equal to “TA-TX” in step 503, the process proceeds to step 504.

In step 504, a determination is made as to whether the user detection device 102 detects that there is a user. If the determination is made that the user detection device 102 detects a user (d=Don), the process returns to step 502, and repeats the above steps. If the determination is made that the user detection device 102 detects that there is no user (d=Doff), the process proceeds to step 505.

In step 505, a determination is made as to whether the present time “t” is greater (later) than “TA-TX”. If a determination is made that “t” is greater than “TA-TX”, the process proceeds to step 506. The flow from step 505 to step 506 corresponds to the transition 412 from the state 410 to the state 440 shown in FIG. 4.

In step 506, the power supply 105 remains on, and the computer 101 learns (determines) that the user has gone out. If the user has gone out in response to the message or the alarm sounded in step 512, for example, the user detection device 102 determines that the state of the user has changed. The user detection device 102 informs the computer 101 of the state d=Doff. If the computer determines that the present time “t” is greater than “TA-TX”, the state of the computer 101 transits from “m=Mwork” to “m=Mout” (corresponding to the state 440 shown in FIG. 4). The process proceeds to step 507.

In step 507, a determination is made of whether the user detection device 102 detects that there is a user. If the determination is made that the user detection device 102 detects a user (d=Don) in step 507, the process returns to step 502, and repeats the above steps. The flow from step 507 to step 502 corresponds to the transition 442 from the state 440 to the state 410 in FIG. 4. If the determination is made in step 507 that the user detection device 102 detects that there is no user (d=Doff), the process proceeds to step 508.

In step 508, a determination is made as to whether “t” is greater (later) than “TA-TY”. If the determination is made that “t” is not greater than “TA-TY”, the process returns to step 506, and repeats steps 506 and 507 until the determination is made that “t” is greater than “TA-TY”. If the determination is made that “t” is greater than “TA-TY”, the process proceeds to step 509. The flow from step 508 to step 509 corresponds to the transition 441 from the state 440 to the state 450 shown in FIG. 4.

In step 509, the power supply 105 is turned off, and the computer 101 knows that the user has gone out. Step 509 corresponds to the state 450 shown in FIG. 4. As described above, when the present time “t” becomes greater than “TA-TY”, the state of the power supply 105 of the computer 101 transits from a state of P=Pon to that of P=Poff.

Finally, the process proceeds to step 510. The power supply 105 of the computer 101 remains turned off.

If a determination is made in step 505 that the present time “t” is not greater than “TA-TX”, the process proceeds to step 514. The state of the schedule manager 104 is changed from m=Mwork to m=Min. The flow from step 505 to step 514 corresponds to the transition 413 from the state 410 to the state 460.

In step 514, the power supply 105 is on and the schedule manager 104 knows that the user has stepped out, instead of having gone out. Step 514 corresponds to the state 460 shown in FIG. 4.

In step 515, a determination is made of whether the user detection device 102 has been detecting a user. If the determination is made that the user detection device 102 has been detecting a user (d=Don), the process returns to step 502 for repeating steps starting with step 502. The flow from step 507 to step 502 corresponds to the transition 462 from the state 460 to the state 410 shown in FIG. 4. If the determination is made in step 515 that the user detection unit 102 has been detecting no user (d=Doff), the process proceeds to step 516.

In step 516, a determination is made as to whether “t” is greater than “TA-TY”. If a determination is made that “t” is not greater than “TA-TY”, the process returns to step 514, and steps 514 and 515 are repeated. If a determination is made that “t” is greater than “TA-TY”, the process proceeds to step 517.

In step 517, a determination is made as to whether the user has set the computer 101 so that, when the user is not around the computer 101, the computer 101 is automatically turned off (as described above, the setting is referred to as c=AutoOn if the computer 101 is to automatically turn off, and c=AutoOff if the computer 101 is not to automatically turn off). If the computer is not set to c=AutoOn (c=AutoOff), the process returns to step 514 without executing any step. That is, when m=Min, and the present time “t” is greater than “TA-TY”, the computer 101 remains in the state m=Min and p=Pon as set by the user. In other words, if c=AutoOn, then when the present time “t” becomes greater than “TA-TY” regardless of “m”, the state of the power supply 105 is turned to p=Poff. If c=AutoOff, the state at time “t” being less than “TA-TY” is maintained.

On the other hand, if c=AutoOn, the process proceeds to step 509. Steps 509 and 510 are executed.

In step 509, since d=Doff, and the present time “t” is greater than “TA-TY”, the state of the computer 101 transits from p=Pon to p=Poff. The flow from step 517 to step 509 corresponds to the transition 461 from the state 460 to the state 450 shown in FIG. 4.

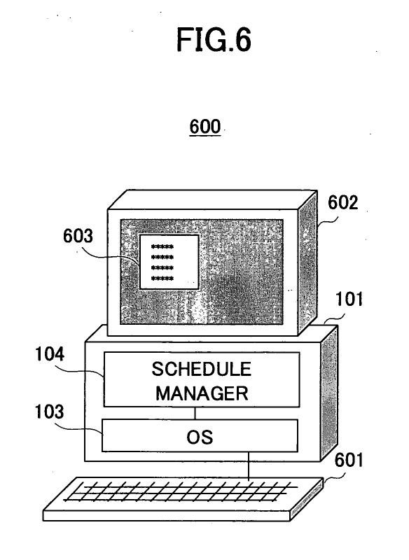

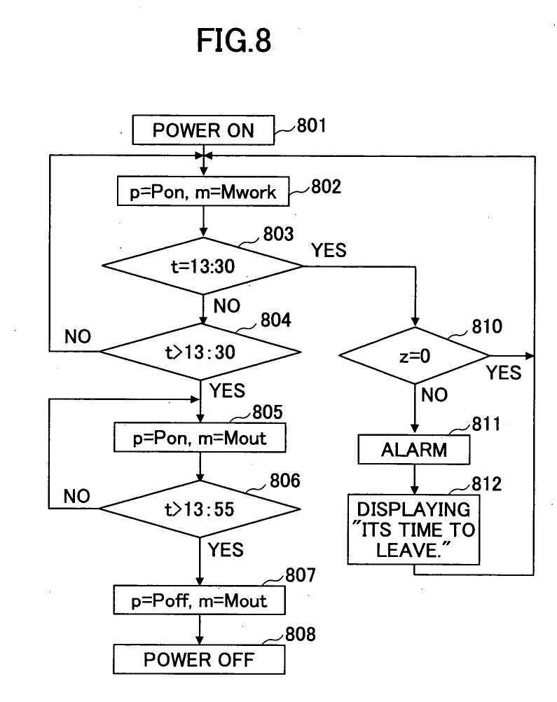

A third embodiment of the present invention is described with reference to FIGS. 6, 7, and 8. FIG. 6 is a schematic diagram showing a computer system 600 according to the third embodiment. Elements identical to those shown in FIG. 1 are referred to by the same reference numerals, and their description is omitted. FIG. 8 is a flowchart showing the operation of the computer 101 according to the third embodiment.

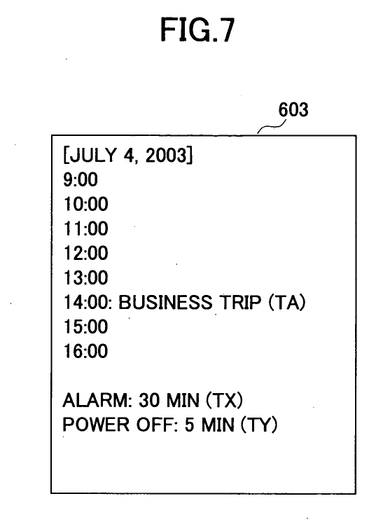

The computer system 600 shown in FIG. 6 includes a computer (processing unit) 101, the operating system 103, the schedule manager (software) 104, a keyboard 601 connected to the computer 101, and a monitor 602 connected to the computer 101. A schedule window 603 is shown on the screen of the monitor 602 by the schedule manager 104 running on the computer 101. FIG. 7 is a schematic diagram showing the schedule window 603.

The exemplary schedule 603 shown in FIG. 7 indicates that the next item of schedule starts at 14:00 (“TA” is 14:00), and the alarm is set at 30 minutes prior to “TA” (“TX” is 30 minutes). The power supply of the computer 101 is to be turned off at 5 minutes prior to “TA” (“TY” is 5 minutes). “t” indicates the present time. “Mwork” denotes a state in which the computer 101 operates normally. “Mout” denotes a state in which the computer 101 knows that the user has gone out, for example. “m” denotes the present state of the computer 101. “Pon” denotes a state in which the power supply 105 is turned on. “Poff” denotes a state in which the power supply 105 is turned off. “p” denotes the present state of the power supply 105. “Z” denotes an operation related to the time “t=TA-TX”. And, “z” denotes the state of a setting. In this case, “Z” is an operation in which a message “It's time to leave.” is displayed.

In step 801 shown in FIG. 8, the computer 101 is turned on. The process proceeds to step 802.

In step 802, the power supply 105 is on, and the computer 101 operates normally.

In step 803, a determination is made as to whether “t” is equal to 13:30. If a determination is made that “t” is equal to 13:30, the process proceeds to step 810.

In step 810, a determination is made as to whether “z=0”. Since an operation is related to “Z”, “z” is not equal to 0. The process proceeds to step 811.

In step 811, the alarm is sounded (or a message is sent), and the process proceeds to step 812. According to these arrangements, when the present time “t” comes to 13:30, the schedule manager 104 can indicate the message or sound the alarm so as to inform the user that time is coming.

In step 812, the operation “Z” related by the user is performed. That is, the message “It's time to leave.” is displayed at “t=13:30”. The process then proceeds to step 802.

In step 803, if a determination is made that “t” is not equal to 13:30, the process proceeds to step 804. In step 804, a determination is made of whether the present time “t” is greater than 13:30. If the present time “t” is not greater than 13:30, the process returns to step 802, and steps 802 and 803 are repeated. If a determination is made that “t” is greater than 13:30, the process proceeds to step 805.

In step 805, the power supply 105 of the computer 101 is on, and the computer 101 knows that the user has gone out. The computer 101 moves from the state m=Mwork to the state m=Mout in response to determination that the present time “t” is greater than 13:30. The process proceeds to step 806.

In step 806, a determination is made of whether “t” is greater than 13:55. If a determination is made that “t” is not greater than 13:55, the process returns to step 805, and repeats step 805. If a determination is made that “t” is greater than 13:55, the process proceeds to step 807.

In step 807, the computer knows that the power supply 105 is turned off, and the user has gone out. When the present time “t” becomes greater (later) than 13:55, the power supply 105 of the computer 101 transits from the state P=Pon to the state P=Poff.

Finally, the process proceeds to step 808, and the power supply 105 of the computer 101 remains turned off.

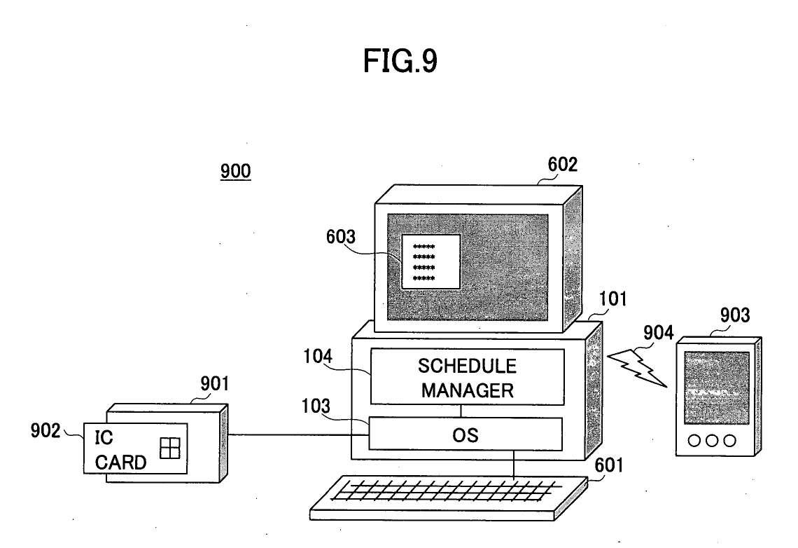

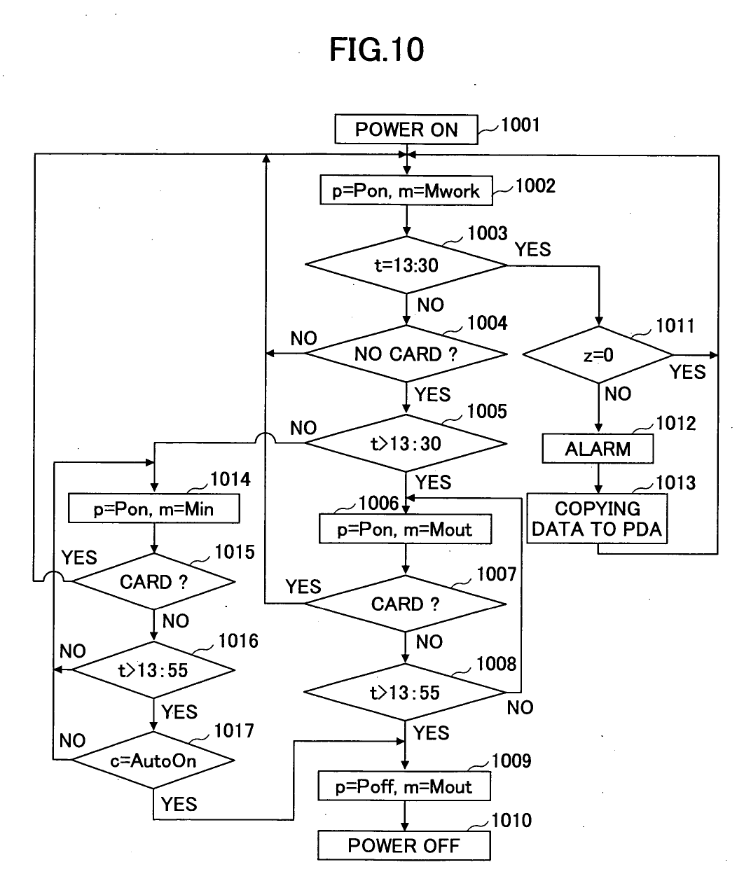

A fourth embodiment of the present invention is described with reference to FIGS. 9 and 10. FIG. 9 is a schematic diagram showing a computer system 900 according to the fourth embodiment. Elements identical to those shown in the previous drawings are referred to by the same reference numerals, and their description is omitted. FIG. 10 is a flowchart showing the operation of the computer 101 according to the fourth embodiment.

The computer system 900 shown in FIG. 9 includes the computer (processing unit) 101, the operating system 103, the schedule manager (software) 104, the keyboard 601 connected to the computer 101, the monitor 602 connected to the computer 101, an IC card reader/writer 901, an IC card 902, and a personal data assistant (PDA) 903. The IC card reader/writer 901 and the IC card constitute the user detection device 102 shown in FIG. 1. The IC card reader/writer 901 and the IC card 902, that is, the user detection device 102, determines that the user is around the computer 101 by determining whether the IC card 902 is set in the IC card reader/writer 901.

In the exemplary embodiment, the user is required to set (insert into and connect to) the IC card in the IC card reader/writer 901 while the user has stepped out. The IC card reader/writer 901 informs the computer 101 that the IC card is set therein (that is, the user has stepped out). The user uses the PDA 903 in addition to the computer system 900. The PDA 903 can exchange data with the computer 101 via a wireless channel 904.

The schedule manager 104 running on the computer 101 displays the schedule window 603 on the monitor 602. An operation “copying a file F to PDA 903” is set as “Z”.

In step 1001 shown in FIG. 10, the power supply 105 is turned on. The process proceeds to step 1002.

In step 1002, the power supply 105 is on, and the computer 101 operates normally.

In step 1003, a determination is made whether “t” is equal to 13:30. If the determination is made that “t” is equal to 13:30, the process proceeds to step 1011.

In step 1011, a determination of whether z=0 is made. Since an operation is set at “Z”, and as a result, z is not equal to 0, the process proceeds to step 1012.

In step 1012, the message is sent and/or the alarm is sounded, and the process proceeds to step 1013. As described above, in the case in which d=Don (a state in which the user detection device 102 detects the user), when the present time “t” becomes equal to 13:30, and if z=0, the schedule manager (software) 104 displays a message or sounds the alarm to inform the user that the time (of the item of schedule) is coming.

In step 1013, the operation Z related by the user is performed. That is, when the present time “t” is equal to 13:30, since “z” is set at “z=Z”, the operation in which the file F is copied to the PDF 903 is performed. The process then proceeds to step 1002.

If a determination is made that “t” is not equal to 13:30 in step 1003, the process proceeds to step 1004.

In step 1004, a determination is made of whether the IC card 902 is set in the IC card reader/writer 901. If the determination is made that the IC card 902 is set in the IC card reader/writer 901 (d=Don), the process returns to step 1002, and repeats the above steps. If the determination is made that the IC card 902 is not set in the IC card reader/writer 901 (d=Doff), the process proceeds to step 1005.

In step 1005, a determination is made whether the present time “t” is greater (later) than 13:30. If a determination is made that “t” is greater than 13:30, the process proceeds to step 1006.

In step 1006, the power supply 105 is on, and the computer 101 learns (determines) that the user has gone out. If the user has gone out in response to the message or the alarm sounded in step 1012, for example, the IC card reader/writer 901 determines that the state of the user has changed. The IC card reader/writer 901 informs the computer 101 of the state d=Doff. If the computer determines that the present time “t” is greater than 13:30, the computer 101 transits from the state “m=Mwork” to the state “m=Mout”. The process proceeds to step 1007.

In step 1007, a determination is made of whether the IC card 902 is set in the IC card reader/writer 901. If the determination is made that the IC card 902 is set in the IC card reader/writer 901 (d=Don) in step 1007, the process returns to step 1002, and repeats the above steps. If the determination is made in step 1007 that the IC card 902 is not set in the IC card reader/writer 901 (d=Doff), the process proceeds to step 1008.

In step 1008, a determination is made of whether “t” is greater (later) than 13:55. If the determination is made that “t” is not greater than 13:55, the process returns to step 1006, and repeats steps 1006 and 1007 until the determination is made that “t” is greater than 13:55. If the determination is made that “t” is greater than 13:55, the process proceeds to step 1009.

In step 1009, the power supply 105 is turned off, and the computer 101 knows that the user has gone out. As described above, when the present time “t” becomes greater than 13:55, the state of the power supply 105 of the computer 101 transits from a state of P=Pon to that of P=Poff.

Finally, the process proceeds to step 1010. The power supply 105 of the computer 101 remains turned off.

If a determination is made in step 1005 that the present time “t” is not greater than 13:30, the process proceeds to step 1014. The state of the schedule manager 104 is changed from m=Mwork to m=Min.

In step 1014, the power supply 105 is on and the schedule manager 104 knows that the user has stepped out, instead of having gone out.

In step 1015, a determination is made of whether the IC card 902 is set in the IC card reader/writer 901. If the determination is made that the IC card 902 is set in the IC card reader/writer 901 (d=Don), the process returns to step 1002 for repeating steps starting with step 1002. If the determination is made in step 1015 that the IC card 902 is not set in the IC card reader/writer 901 (d=Doff), the process proceeds to step 1016.

In step 1016, a determination is made of whether “t” is greater than 13:55. If a determination is made that “t” is not greater than 13:55, the process returns to step 1014, and steps 1014 and 1015 are repeated. If a determination is made that “t” is greater than 13:55, the process proceeds to step 1017.

In step 1017, a determination is made of whether the user has set the computer 101 so that, when the user is not around the computer 101, the computer 101 is automatically turned off (c=AutoOn). If the computer is not set to c=AutoOn (c=AutoOff), the process returns to step 1014 without executing any step. That is, when m=Min, and the present time “t” is greater than 13:55, the computer 101 remains in the state m=Min and p=Pon as set by the user. In other words, if c=AutoOn, then when the present time “t” becomes greater than 13:55 regardless of “m”, the state of the power supply 105 is turned to p=Poff. If c=AutoOff, the state at time “t” being less than 13:55 is maintained.

On the other hand, if c=AutoOn, the process proceeds to step 1009. Steps 1009 and 1010 are executed.

In step 1009, since d=Doff, and the present time “t” is greater than 13:55, the state of the computer 101 transits from p=Pon to p=Poff.

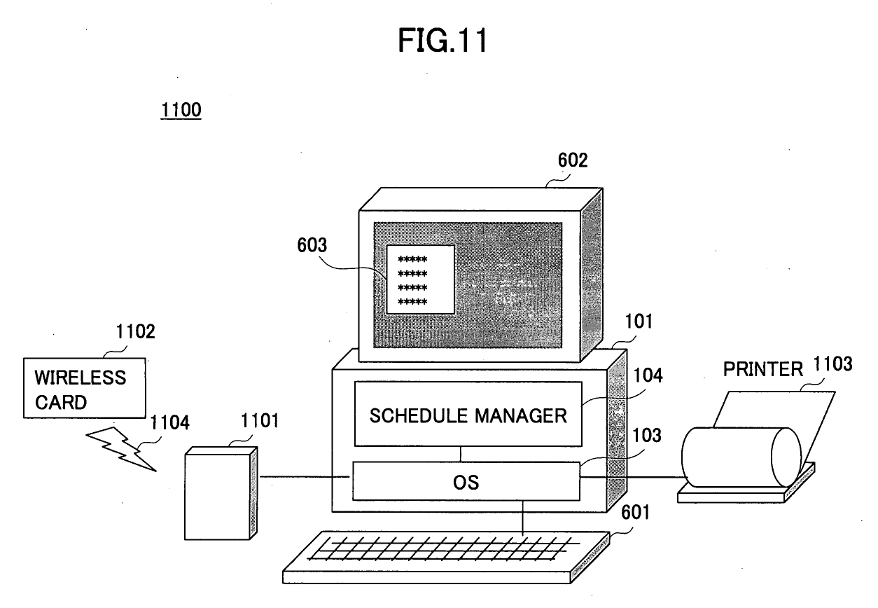

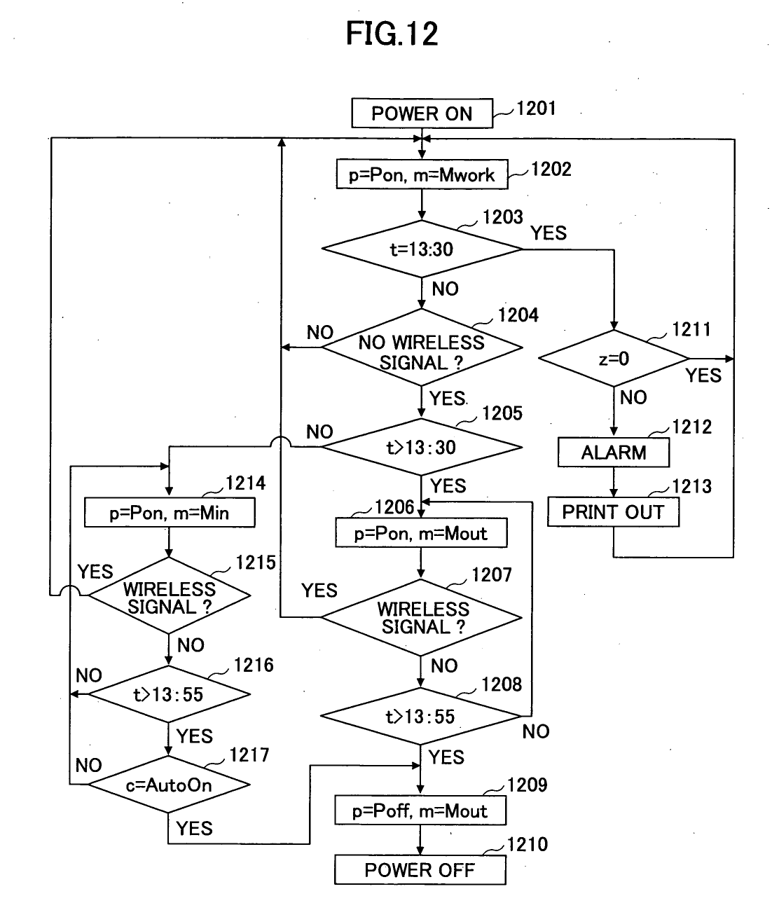

A fifth embodiment of the present invention is described with reference to FIGS. 11 and 12. FIG. 11 is a schematic diagram showing a computer system 1100 according to the fifth embodiment. Elements identical to those shown in the previous drawings are referred to by the same reference numerals, and their description is omitted. FIG. 12 is a flowchart showing the operation of the computer 101 according to the fifth embodiment.

The computer system 1100 shown in FIG. 11 includes the computer (processing unit) 101, the operating system 103, the schedule manager (software) 104, the keyboard 601 connected to the computer 101, the monitor 602 connected to the computer 101, a wireless receiver 1101, a wireless card 1102, and a printer 1103. The wireless receiver 1101 and the wireless card 1102 constitute the user detection device 102 shown in FIG. 1. The wireless receiver 1101 and the wireless card 1102, that is, the user detection device 102, determines that the user is around the computer 101 by determining whether the wireless card 1102 is connected to the wireless receiver 1101 via a wireless communication channel 1104.

The user is required to have the wireless card 1102 to establish connection between the wireless card 1102 and the wireless receiver 1101 via the wireless communication channel 1104. While the user is around the computer 101, the wireless receiver 1101 receives a signal from the wireless card 1102. The wireless receiver 1101 informs the computer 101 that the wireless card 1102 is connected thereto (that is, the user is around). The user may use the printer 1103 for printing data the user needs while going out.

The schedule manager 104 running on the computer 101 displays the schedule window 603 on the monitor 602. The schedule window 603 shown in FIG. 11 is the same as that shown in FIG. 7. An operation “when going out, printing a file F to PDA 903” is set as “Z”.

In step 1201 shown in FIG. 10, the power supply 105 is turned on. The process proceeds to step 1202.

In step 1202, the power supply 105 is on, and the computer 101 operates normally.

In step 1203, a determination is made as to whether “t” is equal to 13:30. If the determination is made that “t” is equal to 13:30, the process proceeds to step 1211.

In step 1211, a determination of whether z=0 is made. Since an operation is set at “Z”, and as a result, z is not equal to 0, the process proceeds to step 1212.

In step 1212, the message is sent and/or the alarm is sounded, and the process proceeds to step 1213. As described above, in the case in which d=Don (a state in which the user detection device 102 detects the user), when the present time “t” becomes equal to 13:30, and if z=0, the schedule manager (software) 104 displays a message or sounds an alarm to inform the user that the time (of the item of schedule) is coming.

In step 1213, the operation Z related by the user is performed. That is, when the present time “t” is equal to 13:30, since “z” is set at “z=Z”, the operation “Z” in which the file F is printed by the printer 1103 is performed. The process then proceeds to step 1202.

If a determination is made that “t” is not equal to 13:30 in step 1203, the process proceeds to step 1204.

In step 1204, a determination is made as to whether the wireless receiver 1101 receives the signal from the wireless card 1102. If a determination is made that the wireless receiver 1101 receives the signal from the wireless card 1102 (d=Don), the process returns to step 1202, and repeats the above steps. If the determination is made that the wireless receiver 1101 does not receive the signal from the wireless card 1102 (d=Doff), the process proceeds to step 1205.

In step 1205, a determination is made whether the present time “t” is greater (later) than 13:30. If a determination is made that “t” is greater than 13:30, the process proceeds to step 1206.

In step 1206, the power supply 105 is on, and the computer 101 learns (determines) that the user has gone out. If the user has gone out in response to the message or the alarm sounded in step 1212, for example, the wireless receiver 1101 determines that the state of the user has changed. The wireless receiver 1101 informs the computer 101 of the state d=Doff. If the computer determines that the present time “t” is greater than 13:30, the computer 101 transits from the state “m=Mwork” to the state “m=Mout”. The process proceeds to step 1207.

In step 1207, a determination is made as to whether the wireless receiver 1101 receives the signal from the wireless card 1102. If a determination is made that the wireless receiver 1101 receives the signal from the wireless card 1102 (d=Don) in step 1207, the process returns to step 1202, and repeats the above steps. If the determination is made in step 1207 that the wireless receiver 1101 does not receive the signal from the wireless card 1102 (d=Doff), the process proceeds to step 1208.

In step 1208, a determination is made as to whether “t” is greater (later) than 13:55. If the determination is made that “t” is not greater than 13:55, the process returns to step 1206, and repeats steps 1206 and 1207 until the determination is made that “t” is greater than 13:55. If the determination is made that “t” is greater than 13:55, the process proceeds to step 1209.

In step 1209, the power supply 105 is turned off, and the computer 101 knows that the user has gone out. As described above, when the present time “t” becomes greater than 13:55, the state of the power supply 105 of the computer 101 transits from a state P=Pon to the state P=Poff.

Finally, the process proceeds to step 1210. The power supply 105 of the computer 101 remains turned off.

If a determination is made in step 1205 that the present time “t” is not greater than 13:30, the process proceeds to step 1214. The state of the schedule manager 104 is changed from m=Mwork to m=Min.

In step 1214, the power supply 105 is on and the schedule manager 104 knows that the user has stepped out, instead of having gone out.

In step 1215, a determination is made as to whether the wireless receiver 1101 receives the signal from the wireless card 1102. If the determination is made that the wireless receiver 1101 receives the signal from the wireless card 1102 (d=Don), the process returns to step 1202 for repeating steps starting with step 1202. If the determination is made in step 1215 that the wireless receiver 1101 does not receive the signal from the wireless card 1102 (d=Doff), the process proceeds to step 1216.

In step 1216, a determination is made as to whether “t” is greater than 13:55. If a determination is made that “t” is not greater than 13:55, the process returns to step 1214, and steps 1214 and 1215 are repeated. If a determination is made that “t” is greater than 13:55, the process proceeds to step 1217.

In step 1217, a determination is made as to whether the user has set the computer 101 so that, when the user is not around the computer 101, the computer 101 is automatically turned off (c=AutoOn). If the computer is not set to c=AutoOn (c=AutoOff), the process returns to step 1214 without executing any step. That is, when m=Min, and the present time “t” is greater than 13:55, the computer 101 remains in the state m=Min and p=Pon as set by the user. In other words, if c=AutoOn, then when the present time “t” becomes greater than 13:55 regardless of “m”, the state of the power supply 105 is turned to p=Poff. If c=AutoOff, the state at time “t” being less than 13:55 is maintained.

On the other hand, if c=AutoOn, the process proceeds to step 1209. Steps 1209 and 1210 are executed.

In step 1209, since d=Doff, and the present time “t” is greater than 13:55, the state of the computer 101 transits from p=Pon to p=Poff.

As described above, it is possible to control the power supply of a computer based on both the state of a user that is determined by the computer and the user's schedule that is input by the user.

The present invention is not limited to these embodiments, but various variations and modifications may be made without departing from the scope of the present invention.

This patent application is based on Japanese priority patent application No. 2003-130561 filed on May 8, 2003, the entire contents of which are hereby incorporated by reference.

What is claimed is:

1. A method of controlling a computer that manages user's schedule, comprising the steps of:
setting a first time;
determining whether a present time is within the first time before a going-out time at which the user is to go out; and
setting the computer in an going-out mode in response to a determination that the present time is within the first time before the going-out time.

2. The method as claimed in claim 1, further comprising the steps of:
setting a second time;
determining whether the present time is within the second time before the going-out time;
controlling a power supply of the computer;
wherein
after the computer is set at the going-out mode, turning the power supply off in response to the determination that the present time is within the second time before the going-out time.

3. The method as claimed in claim 1, further comprising the step of:
causing, in response to the setting of the computer in the going-out mode, the computer to perform a predetermined operation.

4. A method of controlling a computer that manages a user's schedule, the computer having a user detection unit for determining whether a user has left the computer, the method comprising the steps of:
setting a first time;
determining whether a present time is within the first time before a going-out time at which the user is to go out; and
setting, if the user detection unit determines that the user has left the computer, and a determination is made that the present time is not within the first time before the going-out time, the computer in a stepping-out mode, and setting, if a determination is made that the present time is within the first time before the going-out time, the computer in an going-out mode.

5. The method as claimed in claim 4, further comprising the steps of:
setting a second time;
determining whether the present time is within the second time before the going-out time; and
controlling a power supply of the computer;
wherein
after the computer is set in the going-out mode, turning the power supply off in response to the determination that the present time is within the second time before the going-out time.

6. The method as claimed in claim 4, further comprising the step of:
setting a second time;
determining whether the present time is within the second time before the going-out time;
controlling a power supply of the computer;
wherein
after the computer is set in the stepping-out mode, even if the determination is made that the present time is within the second time before the going-out time, maintaining the power supply.

7. The method as claimed in claim 4, further comprising the step of:
causing, in response to the setting of the computer in the going-out mode, the computer to perform a predetermined operation.

8. A computer that manages user's schedule, comprising:
a first time setting unit that sets a first time;
a first determining unit that determines whether a present time is within the first time before a going-out time at which the user is to go out; and
an going-out setting unit that sets the computer in a going-out mode in response to a determination that the present time is within the first time before the going-out time.

9. The computer as claimed in claim 8, further comprising:
a second time setting unit that sets a second time;
a second determining unit that determines whether the present time is within the second time before the going-out time;
a controlling unit that controls a power supply of the computer;
wherein
after the going-out setting unit sets the computer in the going-out mode, the controlling unit turns off the power supply of the computer.

10. The computer as claimed in claim 8, further comprising:
a causing unit that, when said going-out setting unit sets the computer in the going-out mode, causes the computer to perform a predetermined operation.

11. A computer that manages a user's schedule, comprising:
a user detection unit that determines whether a user has left the computer;
a first time setting unit that sets a first time;
a first determining unit that determines whether a present time is within the first time before a going-out time at which the user is to go out; and
a mode setting unit that, if said user detection unit determines that the user has left the computer, and said first determining unit determines that the present time is not within the first time before the going-out time, sets the computer in a stepping-out mode and, if the first determining unit determines that the present time is within the first time before the going-out time, sets the computer in a going-out mode.

12. The computer as claimed in claim 11, further comprising:
a second time setting unit that sets a second time;
a second determining unit that determines whether the present time is within the second time before the going-out time; and
a controlling unit that controls a power supply of the computer;
wherein
after said going-out setting unit sets the computer in the going-out mode, said controlling unit turns off the power supply in response to the second determining unit determining that the present time is within the second time before the going-out time.

13. The computer as claimed in claim 11, further comprising:
a second time setting unit that sets a second time;
a second determining unit that determines whether the present time is within the second time before the going-out time;
a controlling unit that controls a power supply of the computer;
wherein
after said mode setting unit sets the computer in the stepping-out mode, even if said second determining unit determines that the present time is within the second time before the going-out time, said controlling unit maintains the power supply.

14. The computer as claimed in claim 11, further comprising:
a causing unit that, in response to that the mode setting unit sets the computer in the going-out mode, causes the computer to perform a predetermined operation.

15. A computer program that causes a computer managing user's schedule to perform a method comprising the steps of:
setting a first time;
determining whether a present time is within the first time before a going-out time at which the user is to go out; and
setting the computer in an going-out mode in response to a determination that the present time is within the first time before the going-out time.

16. The computer program as claimed in claim 15, the method further comprising the steps of:
setting a second time;
determining whether the present time is within the second time before the going-out time controlling a power supply of the computer;
wherein
after the computer is set in the going-out mode, turning the power supply off in response to the determination that the present time is within the second time before the going-out time.

17. The computer program as claimed in claim 1, the method further comprising the step of:
causing, in response to the setting of the computer in the going-out mode, the computer to perform a predetermined operation.

18. A computer program that causes a computer managing a user's schedule, the computer having a user detection unit for determining whether a user has left the computer, to perform a method comprising the steps of:
setting a first time;
determining whether a present time is within the first time before a going-out time at which the user is to go out; and
setting, if the user detection unit determines that the user has left the computer, and a determination is made that the present time is not within the first time before the going-out time, the computer in a stepping-out mode, and setting, if a determination is made that the present time is within the first time before the going-out time, the computer in a going-out mode.

19. The computer program as claimed in claim 18, the method further comprising the steps of:
setting a second time;
determining whether the present time is within the second time before the going-out time; and
controlling a power supply of the computer;
wherein
after the computer is set in the going-out mode, turning the power supply off in response to the determination that the present time is within the second time before the going-out time.

20. The computer program as claimed in claim 18, the method further comprising the step of:
setting a second time;
determining whether the present time is within the second time before the going-out time;
controlling a power supply of the computer;
wherein
after the computer is set in the stepping-out mode, even if the determination is made that the present time is within the second time before the going-out time, maintaining the power supply.

21. The computer program as claimed in claim 18, the method further comprising the step of:
causing, in response to the setting of the computer in the going-out mode, the computer to perform a predetermined operation.

22. A method of controlling a computer that manages a user's schedule, comprising the steps of:
determining whether the user is using the computer; and
controlling a power supply of the computer based on the user's schedule in response to the determination that the user is not using the computer.

23. A computer that manages user's schedule, comprising:
a determining unit that determines whether the user is using the computer; and
a controlling unit that, in response to said determining unit determining that the user is using the computer, controls a power supply of the computer based on the user's schedule.

24. A computer program that causes a computer managing user's schedule to perform a method comprising the steps of:
determining whether the user is using the computer; and
controlling a power supply of the computer based on the user's schedule in response to the determination that the user is not using the computer.

25. A computer readable recording medium storing the computer program as claimed in claim 15.

26. A computer readable recording medium storing the computer program as claimed in claim 18.

27. A computer readable recording medium storing the computer program as claimed in claim 24.

28. A method of controlling a computer that manages a user's schedule, the computer having a user detection unit, comprising the steps of:
setting a first time;
determining whether a present time is within the first time before a going-out time at which the user is to go out; and
setting, if the user detection unit determines that a user has left the computer, and a determination is made that the present time is not within the first time before the going-out time, the computer in a stepping-out mode.

29. The method as claimed in claim 28, further comprising the step of: setting, if a determination is made that the present time is within the first time before the going-out time, the computer in a going-out mode.

30. The method as claimed in claim 29, further comprising the steps of:
setting a second time;
determining whether the present time is within the second time before the going-out time; and
controlling a power supply of the computer;
wherein
after the computer is set in the going-out mode, turning the power supply off in response to the determination that the present time is within the second time before the going-out time.

31. The method as claimed in claim 29, further comprising the step of:
setting a second time;
determining whether the present time is within the second time before the going-out time;
controlling a power supply of the computer;
wherein
after the computer is set in the stepping-out mode, even if the determination is made that the present time is within the second time before the going-out time, maintaining the power supply.

32. The method as claimed in claim 29, further comprising the step of:
causing, in response to the setting of the computer at the going-out mode, the computer to perform a predetermined operation.

33. A computer that manages a user's schedule, comprising:
a user detection unit that determines whether a user has left the computer;
a first time setting unit that sets a first time;
a first determining unit that determines whether a present time is within the first time before a going-out time at which the user is to go out; and
a stepping-out mode setting unit that, if said user detection unit determines that a user has left the computer, and said first determining unit determines that the present time is not within the first time before the going-out time, sets the computer in a stepping-out mode.

34. The computer as claimed in claim 33, further comprising:
a going-out mode setting unit that, if said first determination unit determines that the present time is within the first time before the going-out time, sets the computer in a going-out mode.

35. The computer as claimed in claim 34, further comprising:
a second setting unit that sets a second time;
a second determining unit that determines whether the present time is within the second time before the going-out time; and
a controlling unit that controls a power supply of the computer;
wherein
after said going-out mode setting unit sets the computer in the going-out mode, said controlling unit turns off the power supply in response to said first determining unit determining that the present time is within the second time before the going-out time.

36. The computer as claimed in claim 34, further comprising:
a second setting unit that sets a second time;
a second determining unit that determines whether the present time is within the second time before the going-out time;
a controlling unit that controls a power supply of the computer;
wherein
after said stepping-out mode setting unit sets the computer in the stepping-out mode, even if said second determination unit determines that the present time is within the second time before the going-out time, said controlling unit maintains the power supply.

37. The computer as claimed in claim 34, further comprising:
a causing unit that causes, in response to said going-out mode setting unit setting the computer in the going-out mode, the computer to perform a predetermined operation.

38. A computer program that causes a computer managing a user's schedule, the computer having a user detection unit for determining whether a user has left the computer, to perform a method comprising the steps of:
setting a first time;
determining whether a present time is within the first time before a going-out time at which the user is to go out; and
setting, if the user detection unit determines that a user has left the computer, and a determination is made that the present time is not within the first time before the going-out time, the computer in a stepping-out mode.

39. The computer program as claimed in claim 38, the method further comprising the step of: setting, if a determination is made that the present time is within the first time before the going-out time, the computer in a going-out mode.

40. The computer program as claimed in claim 39, the method further comprising the steps of:
setting a second time;
determining whether the present time is within the second time before the going-out time; and
controlling a power supply of the computer;
wherein
after the computer is set in the going-out mode, turning the power supply off in response to the determination that the present time is within the second time before the going-out time.

41. The computer program as claimed in claim 39, the method further comprising the steps of:
setting a second time;
determining whether the present time is within the second time before the going-out time;
controlling a power supply of the computer;
wherein
after the computer is set in the stepping-out mode, even if the determination is made that the present time is within the second time before the going-out time, maintaining the power supply.

42. The computer program as claimed in claim 39, the method further comprising the step of:
causing, in response to the setting of the computer in the going-out mode, the computer to perform a predetermined operation.

43. A computer readable recording medium storing the computer program as claimed in claim 38.
